(19) United States
(12) Patent Application Publication
(10) Pub. No.: US 2025/0230664 A1
(43) Pub. Date: Jul. 17, 2025

(54) Threshold Ramp

(71) Applicant: CrossOver Accessibility Solutions, LLC, St. Petersburg, FL (US)

(72) Inventors: Christopher V. Scruci, St. Petersburg, FL (US); Vincent J. Scruci, St. Petersburg, FL (US)

(21) Appl. No.: 19/017,138

(22) Filed: Jan. 10, 2025

Related U.S. Application Data
(60) Provisional application No. 63/620,567, filed on Jan. 12, 2024.

(51) Int. Cl. E04F 11/00; E06B 1/70

(52) U.S. Cl. CPC E04F 11/002; E04F 2011/005; E06B 1/70

(57) ABSTRACT

A threshold ramp adapted to be positioned adjacent to a threshold of a doorway and includes connecting plates; pivot mechanisms connecting the connecting plates; a plurality of ramp sections transversally connected between the connecting plates, U-shaped channels connecting adjacent ramp sections; a locking clamp located at a distal end of each one of the U-shaped channels; a prong located on each one of the U-shaped channels, each one of the prongs engages with the corresponding locking clamp of the U-shaped channel; and cables connecting the connecting plates. Each one of the pluralities of ramp sections rotate independently from each other, in regard to the first and the third connecting plates; and the first and the second pivot mechanisms move the first and the third connecting plates from an undeployed position to a deployed position, extending the ramp sections across the threshold when in the deployed position.

### CROSS-REFERENCE TO RELATED APPLICATIONS

This application claims the benefit of priority to U.S. Provisional Application No. 63/620,567, filed Jan. 12, 2024, entitled, THRESHOLD RAMP the contents of which are incorporated herein by reference.

### FIELD OF THE INVENTION

The invention relates to accessibility ramps. In particular, the present invention relates to threshold ramps to facilitate crossing entryway thresholds, sliding glass door tracks, and uneven surfaces, where a permanent ramp is not possible.

### BACKGROUND OF THE INVENTION

The prior art shows bridge ramps to facilitate the access of wheelchairs, pushchairs, walkers, and strollers, into buildings having an obstruction such as a door threshold at the entrance. Some of the known bridge ramps are foldable to facilitate the storage and transport process.

Unfortunately, the known foldable bridge ramps are heavy and difficult to handle during use. It can be extremely difficult for a person to carry the ramp, deploy the ramp over the barrier, and then remove the ramp after crossing the barrier; thus, disassembling the known foldable bridge ramps after use requires the user to have special skills to handle the bridge ramp from the unfolded position to the folded position.

Furthermore, the wheels of the wheelchairs, pushchairs, walkers, and strollers may be stuck in the hinged ridge that is part of the design of the known bridge ramps.

There is a need for a bridge ramp that overcomes the deficiencies of the known bridge ramps to ease the passage of wheelchairs, pushchairs, walkers, and strollers across entryway thresholds, sliding glass door tracks, and uneven surfaces, where a permanent ramp is not possible.

### SUMMARY OF THE INVENTION

A threshold ramp adapted to be positioned adjacent to a threshold of a doorway and includes connecting plates; pivot mechanisms connecting the connecting plates; a plurality of ramp sections transversally connected between the connecting plates, U-shaped channels connecting adjacent ramp sections; a locking clamp located at a distal end of each one of the U-shaped channels; a prong 42 located on each one of the locking clamps 38, each one of the prongs 42 engages with the corresponding U-shaped channel; and cables connecting the connecting plates. Each one of the pluralities of ramp sections rotate independently from each other, in regard to the first and the third connecting plates; and the first and the second pivot mechanisms move the first and the third connecting plates from an undeployed position to a deployed position, extending the ramp sections across the threshold when in the deployed position.

### BRIEF DESCRIPTION OF THE DRAWINGS

FIG. 1 is a perspective front view of the threshold ramp according to the present invention;

FIG. 2 shows a perspective bottom view of the threshold ramp of FIG. 1;

FIG. 3 shows a perspective front view of the threshold ramp of FIG. 1 in a half-deployed position;

FIG. 4 shows a perspective front view of the threshold ramp of FIG. 1 in the undeployed position;

FIG. 5 shows a side view of the threshold ramp of FIG. 4 in the undeployed position;

FIG. 6 shows a side view of the threshold ramp of FIG. 3 in the half-deployed position;

FIG. 7A shows a side view of the threshold ramp of FIG. 1 in the deployed position on a flatter track/threshold/step;

FIG. 7B shows a side view of the threshold ramp of FIG. 1 in the deployed position on a higher track/threshold/step;

FIG. 8 shows the threshold ramp of FIG. 1 in the undeployed position at a doorway when not in use.

FIG. 9 shows the threshold ramp of FIG. 1 in the half-deployed position at a doorway;

FIG. 10 shows the threshold ramp of FIG. 1 in the deployed position at a door threshold:

FIG. 11 shows the threshold ramp of FIG. 1 in the deployed position at a door threshold and showing a wheelchair passing the door threshold; and

FIG. 12 shows a side view of the threshold ramp of FIG. 1 showing the details of the interconnection between the locking clamps and the prongs inside the U-shaped channels.

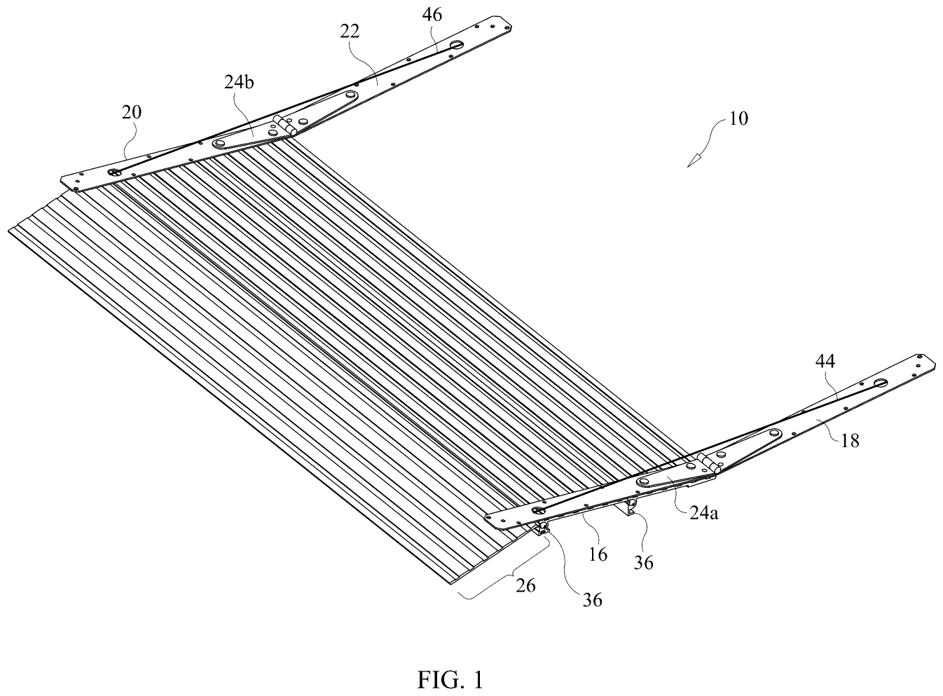

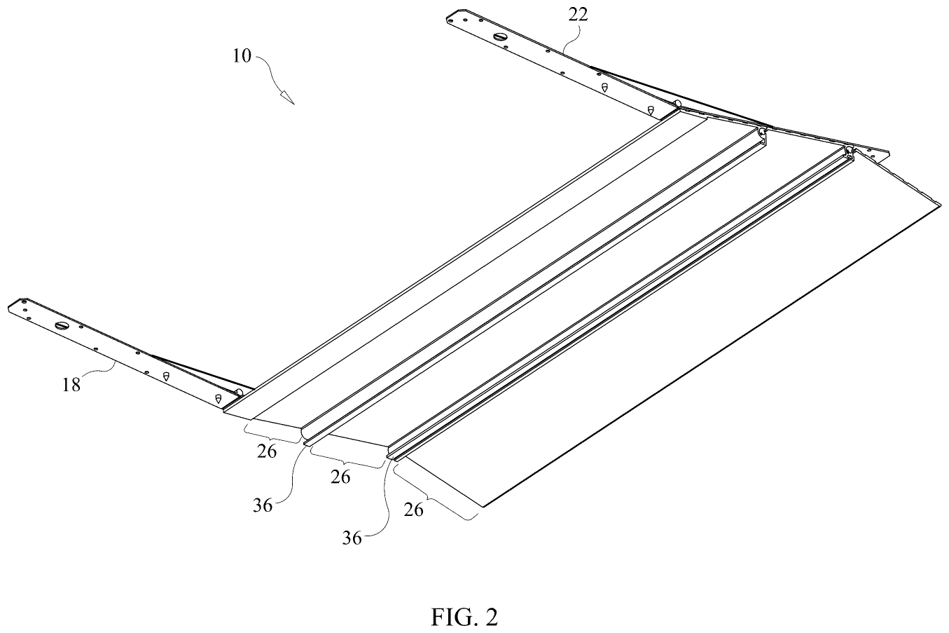

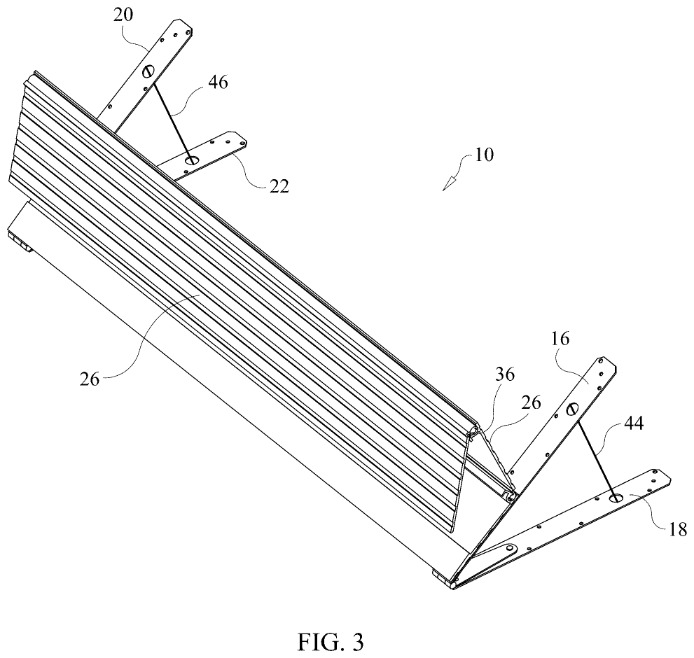

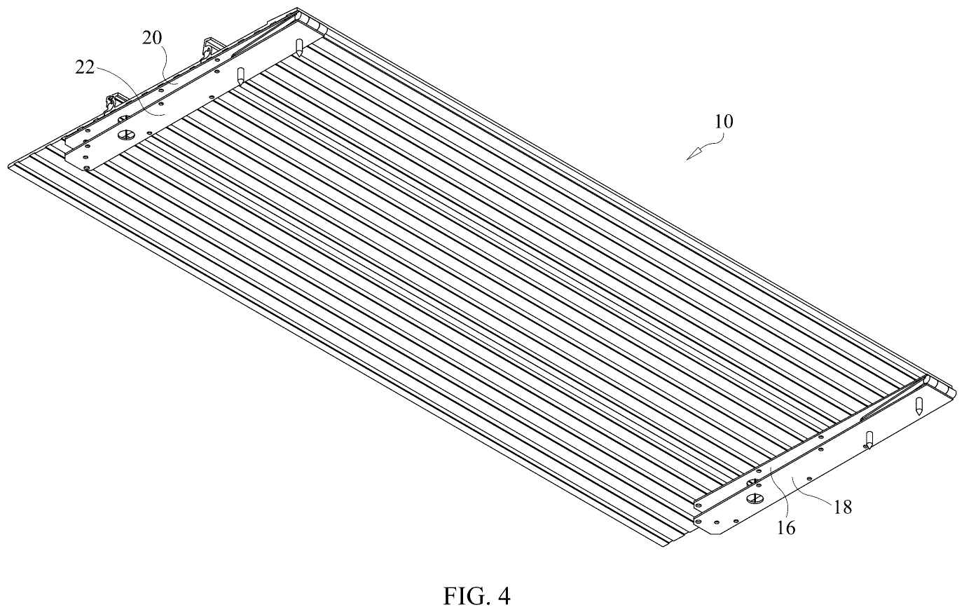

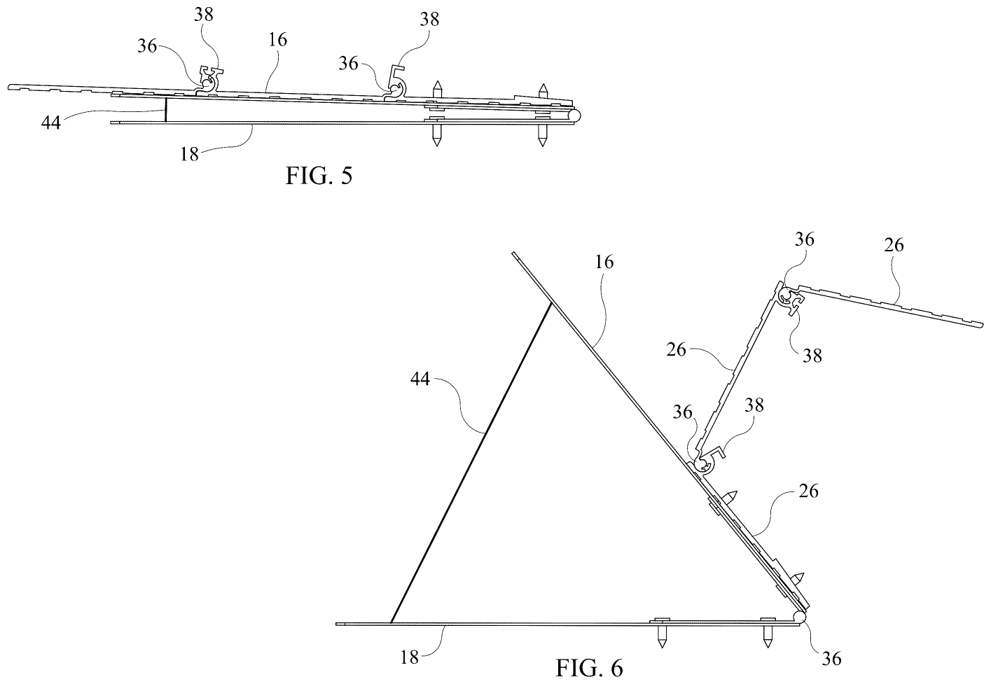

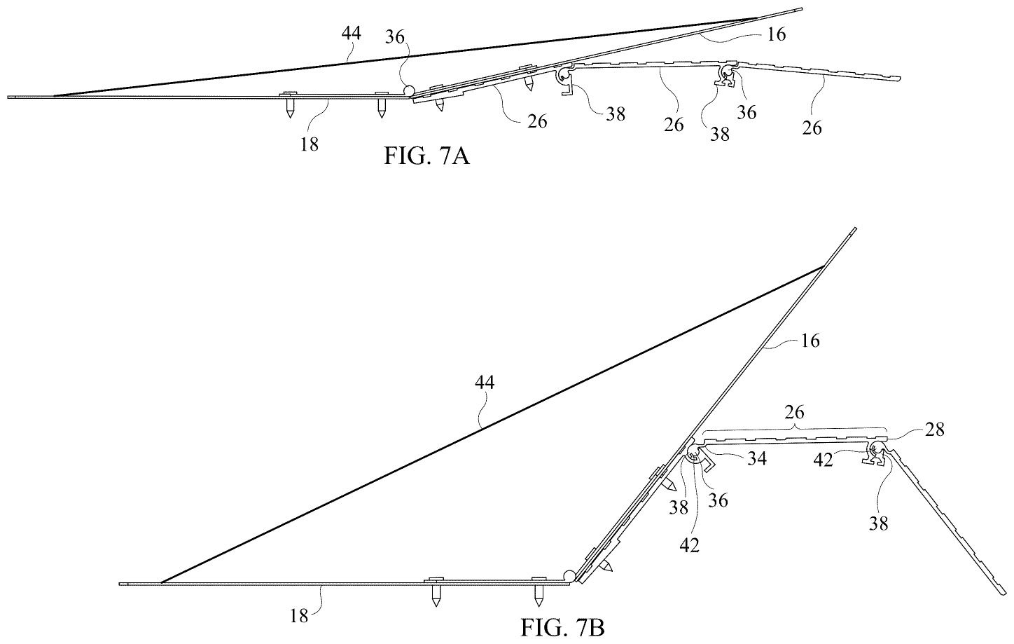

### DETAILED DESCRIPTION OF THE INVENTION

The present invention relates to a threshold ramp 10 fixed on one side of a door accessway that may be easily deployed over the barrier, and then retracted.

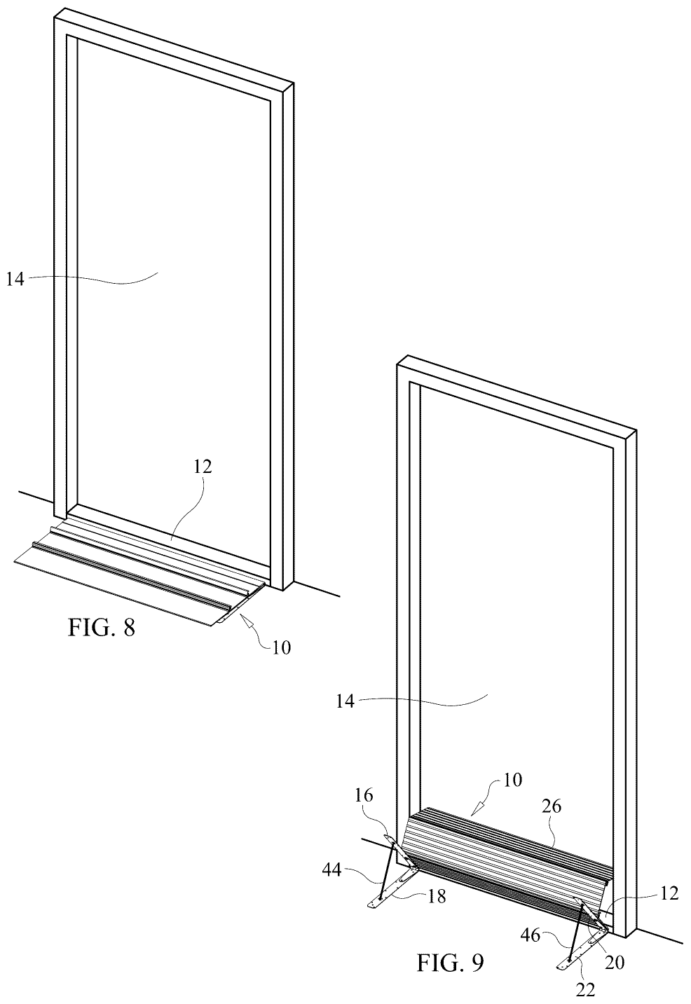

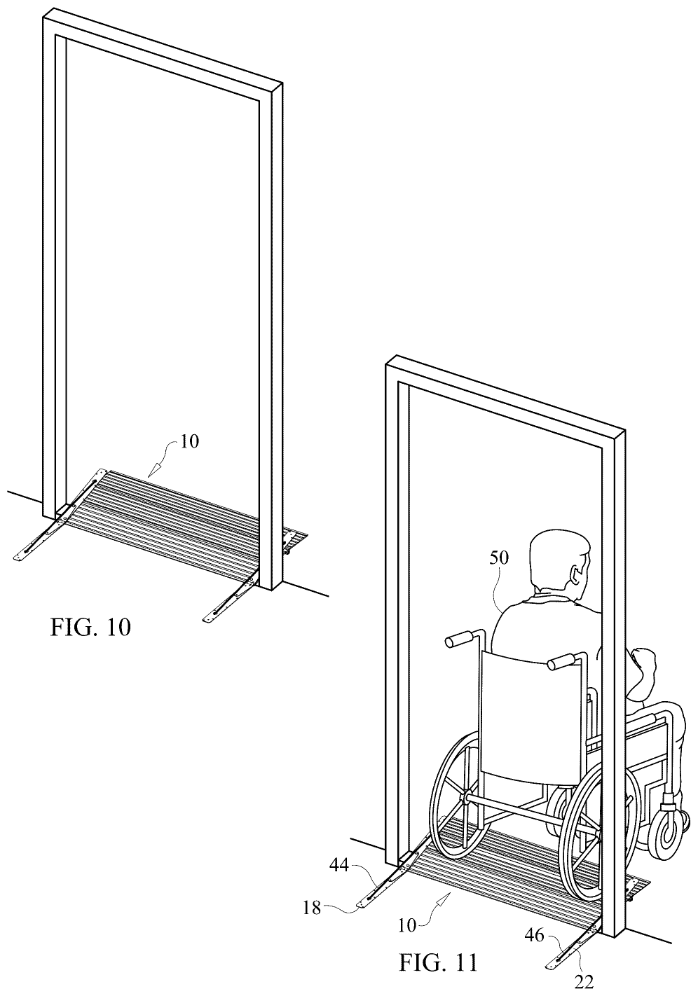

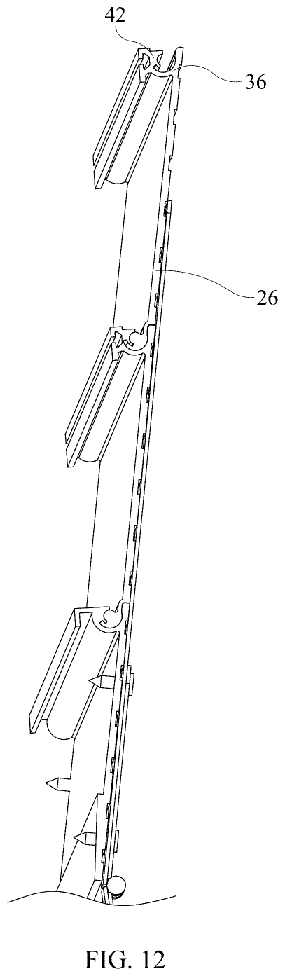

The present invention relates to a threshold ramp 10 adapted to be positioned adjacent to a threshold 12 of a doorway 14 (See FIGS. 8-9). The threshold ramp 10 includes:
a first connecting plate 16;
a second connecting plate 18;
a third connecting plate 20;
a fourth connecting plate 22;
a first pivot mechanism 24a connecting the first connecting plate 16 and the second connecting plate 18;
a second pivot mechanism 24b connecting the third connecting 20 plate and the fourth connecting plate 22;
a plurality of ramp sections 26 transversally connected between the first connecting plate 16 and the third connecting plate 20;
U-shaped channels 36 connecting adjacent ramp sections 26;
a locking clamp 38 located at a distal end of each one of the U-shaped channels 36;
a prong 42 located on each one of the locking clamps 38, each one of the prongs 42 engages with the corresponding U-shaped channel;
a first cable 44 connecting the first connecting plate 16 and the second connecting plate 18;
a second cable 46 connecting the third connecting plate 20 and the fourth connecting plate 22.

The second connecting plate 18 and the fourth connecting plate 22 are fastened to the ground.

A person or machine applying simple mechanical force can deploy the threshold ramp 10 over the door threshold, and then place the threshold ramp 10 back into its undeployed position.

Each one of the pluralities of ramp sections 26 are pivotally connected to the connecting plates 16, 20 and are each pivotable between their undeployed position and their deployed position. Each one of the ramp sections 26 pivots independently from the other ramp sections 26. In a preferred embodiment, each one of the pluralities of ramp sections 26 rotates about 45°.

The plurality of ramp sections 26 may be any commercially available ramp segments. The number of ramp sections 26 is based on the distance between an exterior walking surface and the top of the threshold of the door. The plurality of ramp sections 26 have preferably a flat shape.

The first and the second pivot mechanisms 24a, 24b move the first and the third connecting plates 16, 20 from an undeployed position to a deployed position, and the ramp sections 26 extend across the threshold when in the deployed position.

The pivot mechanisms 24a, 24b facilitate the swiveling of the attached connecting plates from side to side, resulting in an angular range of 25 to 155 degrees.

The pivot mechanisms 24a, 24b may be any commercially available pivot joint. In one embodiment, the first and the second pivot mechanism 24a, 24b are hinges.

The connecting plates 16, 18, 20, 22 may be made of a sturdy material, such as steel, aluminum, or reinforced resin. The length of the connecting plates 16, 18, 20, 22 will depend on the number of ramp sections 26.

The first and the third connecting plates (16, 20) extend over a threshold 12 of a doorway 14 so the threshold ramp can fold back to allow to close the door.

The second and the fourth connecting plates (18, 22) are anchored to the ground or an existing ramp.

The prongs 42 that limit the mobility of the ramp sections 26 to about 45°-60°. This will allow for some flexibility between the ramp sections 26 so that they will be able to take the general shape of the threshold/track/step, but not allow the typical 270° movement.

The cables 44, 46 are attached to the connecting plates (12, 14, 16, 18) to allow the user 50 easy repositioning of the threshold ramp 10. The cables 44, 46 may be any commercially available steel cable.

As the connecting plates are deployed, the ramp sections 36 lay on a door track/threshold/step to ease passage across/over it.

As the connecting plates pull back into their undeployed position, the cables will pull the ramp sections with it. This allows the connecting plates to control the ascent/descent of the threshold ramp 10, while also allowing the ramp sections 26 to move freely and take the shape of the track/threshold/step.

The threshold ramp 10 may include a handle (not shown) attached to the pivot mechanism to allow the user to manually move the connecting plates 16, 20 from a flat undeployed position, up and over the door threshold. The ramp sections 26 fall over the door threshold, forming a gradual incline, and decline to roll/walk over.

In one embodiment, the threshold ramp 10 may include a motor (not shown) remotely activated to operate the threshold ramp 10. The motor may be located at the pivot mechanisms to drive the connecting plates 16, 20 forward, moving the ramp sections from a flat undeployed position, up and over the point of entry. The ramp sections fall over the door threshold, forming a gradual incline, and decline to roll/walk over. When the user has entered/exited, they may use the remote control to bring the connecting plates back to their undeployed position, and the wire will pull the ramp sections back with it, allowing them to fall flat again.

1. A threshold ramp adapted to be positioned adjacent to a threshold of a doorway, the threshold ramp comprising:
a first connecting plate 16;
a second connecting plate 18;
a third connecting plate 20;
a fourth connecting plate 22;
a first pivot mechanism 24a connecting the first connecting plate 16 and the second connecting plate 18;
a second pivot mechanism 24b connecting the third connecting 20 plate and the fourth connecting plate 22;
a plurality of ramp sections 26 transversally connected between the first connecting plate 16 and the third connecting plate 20;
U-shaped channels 36 connecting adjacent ramp sections 26;
a locking clamp 38 located at a distal end of each one of the U-shaped channels 36;
a prong 42 located on each one of the locking clamps 38, each one of the prongs 42 engages with the corresponding U-shaped channel;
a first cable 44 connecting the first connecting plate 16 and the second connecting plate 18;
a second cable 46 connecting the third connecting plate 20 and the fourth connecting plate 22;
wherein each one of the pluralities of ramp sections rotate independently from each other, in regard to the first and the third connecting plates; and
wherein the first and the second pivot mechanisms move the first and the third connecting plates from an undeployed position to a deployed position, extending the ramp sections across the threshold when in the deployed position.

2. The threshold ramp according to claim 1, wherein each one of the plurality of ramps rotates 45°.

3. The threshold ramp according to claim 1, wherein the second and the fourth connecting plates are anchored to the ground or an existing ramp.

4. The threshold ramp according to claim 1, wherein the first and the third connecting plates extend over a threshold of a doorway.

5. The threshold ramp according to claim 1, further including a handle attached to the pivot mechanisms.

6. The threshold ramp according to claim 1, wherein the ramp sections 26 fall over the door threshold, forming a gradual incline, and decline to roll/walk over.

7. The threshold ramp according to claim 1, further including a remotely activated motor attached to the pivot mechanisms.
